(19) United States
(12) Patent Application Publication
(10) Pub. No.: US 2017/0328297 A1
(43) Pub. Date: Nov. 16, 2017

(54) METHOD AND SYSTEM FOR CONTROLLING FUEL PRESSURE VALVE OF VEHICLE

(71) Applicants: Hyundai Motor Company, Seoul (KR); Kia Motors Corp., Seoul (KR)

(72) Inventor: Su Young PARK, Uiwang-si (KR)

(73) Assignees: Hyundai Motor Company, Seoul (KR); Kia Motors Corp., Seoul (KR)

(21) Appl. No.: 15/342,043

(22) Filed: Nov. 2, 2016

(30) Foreign Application Priority Data
May 13, 2016 (KR) 10-2016-0058794

(51) Int. Cl. F02D 41/38; F02D 41/02; F02D 41/04

(52) U.S. Cl. CPC F02D 41/3863; F02D 41/04; F02D 41/021; F02D 2200/0602; F02D 2200/501; F02D 2200/602; F02D 2200/101

(57) ABSTRACT

A method for controlling a fuel pressure valve of a vehicle may include stop entrance, of reducing a target fuel pressure below a predetermined value based on an engine RPM and increasing an allowable deviation between the target fuel pressure and an actual fuel pressure measured by a sensor when a controller determines that a current vehicle speed is equal to or lower than a reference vehicle speed, and pressing of an acceleration pedal is released, fuel pressure determination, of determining whether a deviation value between the target fuel pressure and the measured actual fuel pressure is greater than the allowable deviation, and valve control, of determining a duty value of the fuel pressure valve when the deviation value between the target fuel pressure and the measured actual fuel pressure is greater than the allowable deviation, and then controlling to open the fuel pressure valve using the determined duty value.

### CROSS-REFERENCE TO RELATED APPLICATION

The present application claims priority to Korean Patent Application No. 10-2016-0058794, filed May 13, 2016, the entire contents of which is incorporated herein for all purposes by this reference.

### BACKGROUND OF THE INVENTION

### Field of the Invention

The present invention relates to a method and system for controlling a fuel pressure valve of a vehicle, and more particularly to a method and system for controlling a fuel pressure valve to adjust the pressure of a fuel supplied to a fuel injector.

### Description of Related Art

Vehicles may be equipped with a common rail for injecting a fuel at a predetermined high pressure or above. Meanwhile, common rail type engines may be equipped with a fuel pressure valve for adjusting a fuel pressure by feeding back a fuel present in a common rail to a fuel tank.

Such a fuel pressure valve may be of a mechanical type or a solenoid type. In particular, the solenoid type fuel pressure valve is opened when an actual fuel pressure measured by a fuel pressure sensor provided at a common rail differs from a target fuel pressure, to feed back a fuel to a fuel tank, and, as such, the pressure of the fuel present in the common rail approaches the target fuel pressure.

In order for the actual fuel pressure to effectively approach the target fuel pressure, the fuel pressure valve operates repeatedly while being controlled using a duty valve. In a state in which the difference between the actual fuel pressure and the target fuel pressure is small, and such a small difference is maintained, the operation of the fuel pressure valve is continuously carried out and, as such, operation noise may be increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method and system for controlling a fuel pressure valve of a vehicle to effectively reduce noise generation of a fuel pressure valve to adjust the fuel pressure of a common rail.

According to various aspects of the present invention, a method for controlling a fuel pressure valve of a vehicle may include stop entrance, by a controller, of reducing a target fuel pressure below a predetermined value based on an engine RPM and increasing an allowable deviation between the target fuel pressure and an actual fuel pressure measured by a sensor when the controller determines that a current vehicle speed is equal to or lower than a reference vehicle speed, and pressing of an acceleration pedal is released, fuel pressure determination, by the controller, of determining whether a deviation value between the target fuel pressure and the measured actual fuel pressure is greater than the allowable deviation, and valve control, by the controller, of determining a duty value of the fuel pressure valve when the deviation value between the target fuel pressure and the measured actual fuel pressure is greater than the allowable deviation, and then controlling, by the controller, to open the fuel pressure valve using the determined duty value, thereby decreasing the actual fuel pressure.

The target fuel pressure may be maintained at a reference fuel pressure after being decreased to be equal to the reference fuel pressure.

The reference fuel pressure may have a value equal to a predetermined value of the target fuel pressure determined based on an engine RPM in a stop state, before the stop entrance.

The target fuel pressure may be decreased to be equal to the reference fuel pressure at the stop entrance before the engine RPM reaches a predetermined reference revolutions per minute (RPM) set in the controller through decrease thereof.

At the stop entrance, the controller may decrease the target fuel pressure while increasing the allowable deviation when the vehicle is in a neutral state, the vehicle speed is equal to or lower than the reference vehicle speed, and pressing of the acceleration pedal is released.

At the stop entrance, the target fuel pressure may be decreased, and the allowable deviation may be increased when the target fuel pressure has a value equal to or lower than a change fuel pressure, and the engine RPM has a value equal to or lower than a change RPM in a state in which the vehicle speed is equal to or lower than the reference vehicle speed, and pressing of the acceleration pedal is released.

The method may further include return determination, by the controller, of determining whether a current engine RPM is equal to or lower than a return RPM, upon determining, at the fuel pressure determination, that the deviation value between the target fuel pressure and the actual fuel pressure is equal to or lower than the allowable deviation, and return, by the controller, of returning the target fuel pressure to the predetermined value determined based on the engine RPM upon determining, at the return determination, that the engine RPM is equal to or lower than the return RPM, and controlling the controller to return the allowable deviation to a value maintained before being increased at the stop entrance.

According to various aspects of the present invention, a system for controlling a fuel pressure valve of a vehicle may include a fuel pressure valve controlled using a duty value, to be opened or closed, the fuel pressure valve functioning to return, to a fuel tank, a fuel supplied to an injector by a fuel pump to achieve a reduction in fuel pressure, sensors for measuring a vehicle speed, an engine revolutions per minute (RPM), and a current actual fuel pressure, and a controller for decreasing a target fuel pressure of the vehicle below a predetermined value determined based on an engine RPM while increasing an allowable deviation between the target fuel pressure and an actual fuel pressure measured by the sensors upon determining that the vehicle speed is equal to or lower than a reference vehicle speed, and pressing of the acceleration pedal is released, the controller determining whether a deviation value between the target fuel pressure and the measured actual fuel pressure is greater than the allowable deviation, determining a duty value of the fuel pressure valve based on the deviation value when the deviation value between the target fuel pressure and the measured actual fuel pressure is greater than the allowable deviation, and then opening the fuel pressure valve using the determined duty value, thereby decreasing the actual fuel pressure.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating a method for controlling a fuel pressure valve of a vehicle in accordance with various embodiments of the present invention;

FIG. 2 is a diagram illustrating a system for controlling a fuel pressure valve of a vehicle in accordance with various embodiments of the present invention; and

FIG. 3 is a graph depicting operation of the fuel pressure valve controlled through the vehicle fuel pressure valve control method according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

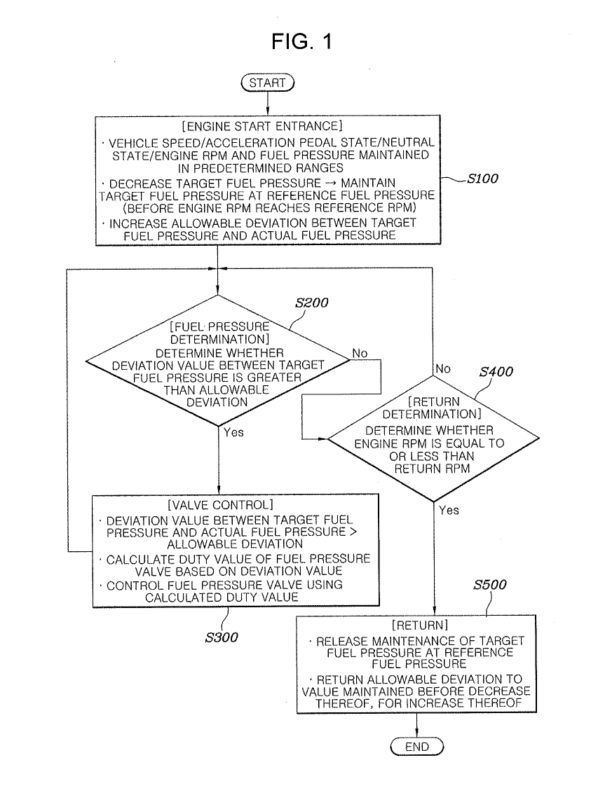

Referring to FIGS. 1 to 3, a method for controlling a fuel pressure valve 150 of a vehicle in accordance various embodiments of the present invention is illustrated. As illustrated in FIGS. 1 to 3, the control method includes stop entrance S100 for controlling a controller 200 to reduce a target fuel pressure below a predetermined value determined based on an engine RPM and to increase an allowable deviation between the target fuel pressure and an actual fuel pressure measured by a sensor when the controller 200 determines that a current vehicle speed is equal to or lower than a reference vehicle speed, and pressing of an acceleration pedal is released, fuel pressure determination S200 for controlling the controller 200 to determine whether a deviation value between the target fuel pressure and the measured actual fuel pressure is greater than the allowable deviation, and valve control S300 for controlling the controller 200 to determine a duty value of the fuel pressure valve 150 when the deviation value between the target fuel pressure and the measured actual fuel pressure is greater than the allowable deviation, and then controlling the controller 200 to open the fuel pressure valve 150 using the determined duty value, thereby decreasing the actual fuel pressure.

This will be described in detail. At the stop entrance S100, the controller 200 reduces a target fuel pressure below a predetermined value determined based on an engine RPM while increasing the allowable deviation between the target fuel pressure and the actual fuel pressure measured by the sensor upon determining that the current vehicle speed is equal to or lower than the reference vehicle speed, and pressing of the acceleration pedal is released.

In the present invention, the state in which the current vehicle speed is equal to or lower than the reference vehicle speed, and pressing of the acceleration pedal is released is determined as a situation in which the vehicle enters a stop state. The reference vehicle speed is a value theoretically or experimentally determined to define a stop state of the vehicle. The reference vehicle speed should be determined to have a value similar to a vehicle speed of the vehicle establishable even in a state in which the acceleration pedal is not pressed. In particular, the reference vehicle speed is preferably determined to be on the order of a vehicle speed established during creeping of the vehicle. For example, the reference vehicle speed may be determined to be 1 Km/h.

When the vehicle enters a stop state, the engine RPM thereof is reduced and, as such, is maintained at a minimum RPM, for example, an idle RPM. The controller 200 calculates a target fuel pressure in accordance with the engine RPM. Accordingly, when the vehicle enters a stop state, the target fuel pressure is gradually decreased in accordance with a decrease in engine RPM and, as such, has a minimum value corresponding to a minimum RPM. In the present invention, such a value of the target fuel pressure, which is generally determined, is represented as a predetermined value.

Meanwhile, when the target fuel pressure decreases, the deviation value between the actual fuel pressure and the target fuel pressure is increased. When the deviation value increases over an allowable deviation, the fuel pressure valve 150 operates to cause the actual fuel pressure to be equal to the target fuel pressure.

The allowable deviation is theoretically or experimentally determined to cause the actual fuel pressure to approach to the target fuel pressure in a general travel state. The allowable deviation may be determined to have various values. For enhanced approach of the actual fuel pressure to the target fuel pressure, the allowable deviation preferably has a relatively low value. For example, the allowable deviation may be on the order of 3 to 4 MPa.

In various embodiments of the present invention, the fuel pressure valve 150 is mounted to the common rail 20, to feed back a fuel to a fuel tank 30 when opened. As a portion of the fuel present in the common rail 20 is fed back, the actual fuel pressure is decreased. Thus, the actual fuel pressure measured by the sensor unit 220 approaches the target fuel pressure.

In various embodiments of the present invention, the fuel pressure valve 150 is controlled using a duty value. The duty value may be determined in accordance with the deviation value between the actual fuel pressure and the target fuel pressure. That is, as the deviation value between the actual fuel pressure at the current time and the target fuel pressure increases, the duty value for opening of the fuel pressure valve 150 is determined to have an increased value.

Meanwhile, in a conventional case, when the vehicle enters a stop state, the engine RPM of the vehicle is decreased, as described above. In this case, when the deviation value between the target fuel pressure and the actual fuel pressure is greater than the allowable deviation, the fuel pressure valve 150 is opened to decrease the actual fuel pressure. During decrease of the actual fuel pressure, the target fuel pressure is also continuously decreased and, as such, the fuel pressure valve 150 is again opened, and this situation is repeated.

In particular, when the engine RPM is decreased to a predetermined level or below, noise caused by the engine is gradually reduced. As a result, the level of operation noise of the fuel pressure valve 150 recognized by a passenger is increased. Accordingly, it is more important to reduce operation noise of the fuel pressure valve 150.

In a state in which the engine RPM is decreased, the deviation value between the actual fuel pressure and the target fuel pressure is small because the actual fuel pressure approaches the target fuel pressure and, as such, has a value similar to the target fuel pressure. Accordingly, the fuel pressure valve 150 is operated by a decreased duty value, and the number of times when the fuel pressure valve 150 is abruptly increased. As a result, operation noise is increased.

In various embodiments of the present invention, upon determining that the vehicle enters a stop state, the target fuel pressure, which has been determined based on an engine RPM, is abruptly decreased below a predetermined value. In this case, the decrease rate of the target fuel pressure, which is greatly decreased in accordance with the present invention, may be theoretically or experimentally determined. For example, the target fuel pressure may be determined to reach a minimum value at a high rate corresponding to several times the rate at which the target fuel pressure reaches the predetermined value.

As the target fuel pressure is abruptly decreased, the time at which the target fuel pressure reaches a minimum value for a stop state of the vehicle is decreased and, as such, the approach period of the actual fuel pressure approaching the target fuel pressure is also reduced. That is, the operation period of the fuel pressure valve 150 for approach of the actual fuel pressure to the target fuel pressure is reduced, and the engine RPM is decreased to a predetermined level or below. As a result, operation of the fuel pressure valve 150 is completed before a situation, in which noise of the fuel pressure valve 1509 is more apparently recognized by a passenger, occurs. Accordingly, it may be possible to effectively reduce operation noise of the fuel pressure valve 150 transmitted to the passenger.

In addition, in various embodiments of the present invention, upon determining that the vehicle enters a stop state, the allowable deviation between the actual fuel pressure and the target fuel pressure is greatly increased over the predetermined value. In this case, the increase rate of the target fuel pressure, which is greatly increased in accordance with the present invention, may be theoretically or experimentally determined. For example, the target fuel pressure may be determined to be a high value corresponding to several times the predetermined value, for example, 10 MPa.

As the allowable deviation increases, the duty value of the fuel pressure valve 150 operating to cause the actual fuel pressure to approach the target fuel pressure, which is gradually decreased, is greatly increased, and the number of times when the fuel pressure valve 150 operates is greatly decreased, as compared to the conventional case.

In a stop state in which the speed of the vehicle is equal to or lower than the reference vehicle speed, and the acceleration pedal is not pressed, there is no problem even when the accuracy of the fuel pressure valve 150 for approach of the actual fuel pressure to the target fuel pressure is slightly lower than that in a general vehicle travel state. Rather, it is advantageous to reduce the number of times when the fuel pressure valve 150 operates so as to reduce operation noise in this case.

In various embodiments of the present invention, accordingly, upon determining, by the controller 200, that the vehicle is in a stop state, the allowable deviation between the actual fuel pressure and the target fuel pressure is greatly increased over the predetermined value, which is used in the conventional case, and, as such, the number of times when the fuel pressure valve 150 operates is reduced, thereby reducing operation nose. When the target fuel pressure corresponds to a minimum value and, as such, has a normal level, the deviation value between the actual fuel pressure and the target pressure value becomes equal to or lower than the allowable deviation.

In this state, although the fuel pressure valve 150 does not operate, the actual fuel pressure is gradually decreased in accordance with fuel injection of the injector and, as such, approaches the target fuel pressure. In this case, control of the fuel pump is also carried out. As a result, when the deviation value between the actual fuel pressure and the target fuel pressure is equal to or lower than the allowable deviation, the actual fuel pressure approaches the target fuel pressure even though the fuel pressure valve does not operate. Accordingly, it may be possible to greatly reduce operation noise of the fuel pressure valve 150.

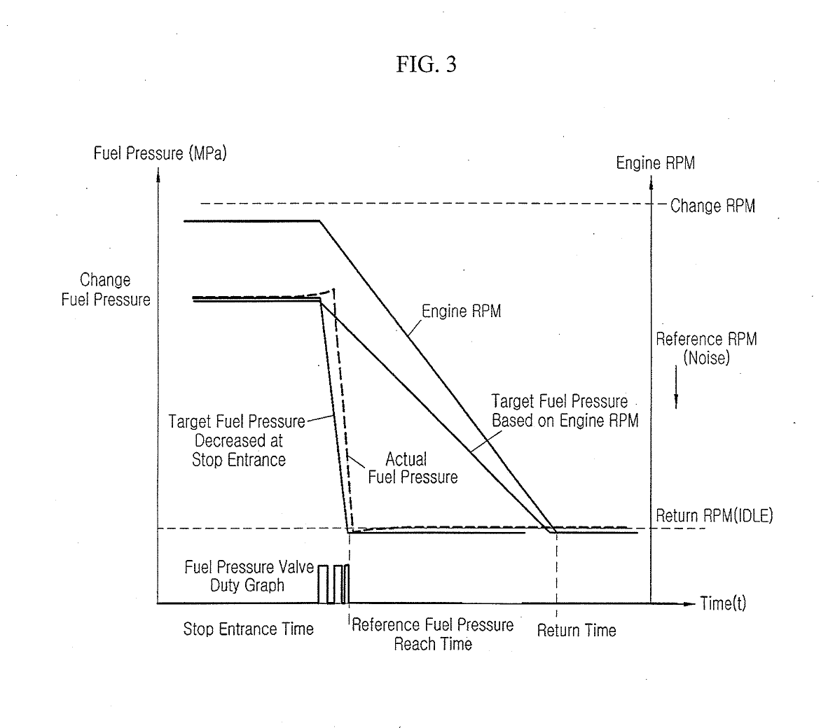

In a graph of FIG. 3, the target fuel pressure, which has been decreased below a predetermined value used in the conventional case, after the vehicle enters a stop state, is illustrated. The graph also briefly illustrates an operation period of the fuel pressure valve 150 associated with the target fuel pressure decrease.

Meanwhile, at the fuel pressure determination S200, the controller 200 determines whether the deviation value between the target fuel pressure and the measured actual fuel pressure is greater than the allowable deviation.

As described above, in various embodiments of the present invention, the allowable deviation between the target fuel pressure and the actual fuel pressure is greatly increased over the predetermined value. Using the allowable deviation increased as described above, whether the fuel pressure valve 150 should operate is determined.

Meanwhile, at the valve control S300, the controller 200 determines the duty value of the fuel pressure valve 150 in accordance with the deviation value, upon determining, at the fuel pressure determination S200, that the deviation value is greater than the allowable deviation. The controller 200 then opens the fuel pressure valve 150 using the determined duty value, thereby decreasing the actual fuel pressure.

That is, at the valve control S300, the duty value of the fuel pressure valve 150 is increased because the fuel pressure valve 150 operates in accordance with the allowable deviation increased as described above. In addition, the number of times when the fuel pressure valve 150 operates is decreased. As a result, noise caused by operation of the fuel pressure valve 150 is reduced.

In the present invention, accordingly, upon determining that the vehicle enters a stop state, the target fuel pressure, which has been slowly decreased in accordance with the engine RPM, is greatly decreased below the predetermined value and, as such, the time when the target fuel pressure reaches a normal level is advanced. Accordingly, operation of the fuel pressure valve 150 is completed before the engine RMP reaches a level at which operation of the fuel pressure valve 150 is recognized by the passenger as noise. Thus, operation noise of the fuel pressure valve 150 is greatly reduced.

In addition, in a stop state of the vehicle in which there is no problem even when the sensitivity of approach of the actual fuel pressure to the target fuel pressure is slightly lower than that in a vehicle travel state, the allowable deviation between the actual fuel pressure and the target fuel pressure is greatly increased over the predetermined value, to reduce the number of times when the fuel pressure valve 150 operates. Thus, generation of noise caused by operation of the fuel pressure valve 150 is greatly reduced.

Meanwhile, as illustrated in FIGS. 1 to 3, in the vehicle fuel pressure valve control method according to the illustrated embodiment of the present invention, the target fuel pressure is decreased to be equal to a reference fuel pressure, and is then maintained at the reference fuel pressure.

In various embodiments of the present invention, the target fuel pressure, which has been determined based on an engine RPM, is abruptly decreased below the predetermined value. Even when the vehicle enters a stop state, idle-level driving is carried out. To this end, the target fuel pressure should be maintained at a certain level. In the present invention, accordingly, the target fuel pressure is maintained at a reference fuel pressure after being abruptly decreased.

In this case, the reference fuel pressure has various values. The reference fuel pressure is preferably determined to have a value greater than a minimum level of the predetermined value, which is determined based on an engine RPM. FIG. 3 illustrates, through a graph, the target fuel pressure, which is abruptly decreased, and is then maintained at the reference fuel pressure after reaching the reference fuel pressure.

Meanwhile, as illustrated in FIGS. 1 to 3, in the vehicle fuel pressure valve control method according to various embodiments of the present invention, the reference fuel pressure has the same value as the predetermined value of the target fuel pressure determined based on the engine RPM in a stop state, before the stop entrance S100.

As described above, the minimum level of the predetermined value determined based on an engine RPM in the conventional case is determined for engine driving in a stop state. In various embodiments of the present invention, the reference fuel pressure is determined to be equal to the minimum level. FIG. 3 illustrates, through a graph, the reference fuel pressure according to the illustrated embodiment of the present invention, which is set to be equal to the minimum level of the predetermined value determined based on an engine RPM in association with the target fuel pressure in the conventional case.

Accordingly, even when the target fuel pressure is returned to the predetermined value determined based on an engine RPM in the conventional case, after completion of the target fuel pressure control carried out during stop entrance in accordance with the present invention, the actual fuel pressure satisfies the target fuel pressure without being remarkably varied. In this case, accordingly, no additional operation of the fuel pressure valve 150 is required and, as such, generation of operation noise is prevented.

Meanwhile, as illustrated in FIGS. 1 to 3, in the vehicle fuel pressure valve control method according to various embodiments of the present invention, the target fuel pressure is decreased to be equal to the reference fuel pressure at the stop entrance S100 before the engine RPM reaches a predetermined reference RPM set in the controller 200 through decrease thereof.

In detail, in various embodiments of the present invention, the target fuel pressure is greatly decreased below the predetermined value. The decrease rate of the target fuel pressure may be determined in various manners, as described above. The target fuel pressure is decreased to reach the reference fuel pressure, at least before the engine RPM, which is decreased when the vehicle enters a stop state, reaches the reference RPM.

As described above, when the engine RPM is greater than a predetermined level, the level of operation noise of the fuel pressure valve 150 recognized by a passenger is relatively low. However, when the engine RPM is decreased to the predetermined level or below, operation noise of the fuel pressure valve 150 is more readily heard by the passenger. In this state, accordingly, it is more important to reduce operation noise of the fuel pressure valve 150.

In various embodiments of the present invention, the engine RPM at the time when operation noise of the fuel pressure valve 150 is recognized by the passenger as noise, is defined as the reference RPM. The reference RPM may be determined in various manners, based on experimental results.

That is, in various embodiments of the present invention, the target fuel pressure is decreased to the reference fuel pressure before the engine RPM reaches the reference RPM and, as such, influence of operation noise of the fuel pressure valve 150 on the passenger as noise is minimized.

Meanwhile, as illustrated in FIGS. 1 to 3, in the vehicle fuel pressure valve control method according to various embodiments of the present invention, at the stop entrance S100, the controller 200 decreases the target fuel pressure while increasing the allowable deviation when the vehicle is in a neutral state, the vehicle speed is equal to or lower than the reference vehicle speed, and pressing of the acceleration pedal is released.

In detail, in a heavy vehicle or the like, acceleration may be carried out in a neutral state of the vehicle by temporarily pressing the acceleration pedal, to temporarily increase the engine RPM before travel start. This is because, when the vehicle is heavy or the engine load upon start of the vehicle is great, the engine RPM and engine torque may have difficulty overcoming the load upon start of the vehicle.

In various embodiments of the present invention, a state, in which the vehicle speed is equal to or lower than the reference vehicle speed, and pressing of the acceleration pedal is released, is determined in a neutral state of the vehicle, in order to prevent a situation in which operation noise of the fuel pressure valve 150 is continuously generated as the target fuel pressure is varied in accordance with the engine RPM decreased after being temporarily increased in the above-described acceleration state, as in the conventional case.

Meanwhile, as illustrated in FIGS. 1 to 3, in the vehicle fuel pressure valve control method according to various embodiments of the present invention, at the stop entrance S100, the target fuel pressure is decreased, and the allowable deviation is increased when the target fuel pressure has a value equal to or lower than a change fuel pressure, and the engine RPM has a value equal to or lower than a change RPM in a state in which the vehicle speed is equal to or lower than the reference vehicle speed, and pressing of the acceleration pedal is released.

In detail, generation of operation noise of the fuel pressure valve 150 to be reduced in the present invention occurs even in a stop state of the vehicle, in particular, in a state in which the engine RPM is relatively low, and the target fuel pressure is relatively low.

To this end, in various embodiments of the present invention, in order to more concretely define a situation requiring reduction of operation noise of the fuel pressure valve 150, adjustment of the target fuel pressure and allowable deviation is carried out when the engine RPM is equal to or lower than the change RPM, and the target fuel pressure according to the predetermined value is equal to or lower than the change fuel pressure.

In this case, the change RPM and change fuel pressure may have various values determined in various manners based on experimental results or theoretical basis. The change RPM and change fuel pressure are preferably determined by an engine RPM determined to be greater than the reference RPM in accordance with the level of importance of operation noise of the fuel pressure valve 150, and a target fuel pressure according to the determined engine RPM, respectively.

Meanwhile, as illustrated in FIGS. 1 to 3, the vehicle fuel pressure valve control method according to various embodiments of the present invention further includes return determination S400 for controlling the controller 200 to determine whether the current engine RPM is equal to or lower than a return RPM, upon determining, at the fuel pressure determination S200, that the deviation value between the target fuel pressure and the actual fuel pressure is equal to or lower than the allowable deviation, and return S500 for controlling the controller 200 to return the target fuel pressure to the predetermined value determined based on the engine RPM upon determining, at the return determination S400, that the engine RPM is equal to or lower than the return RPM, and controlling the controller 200 to return the allowable deviation to a value maintained before being increased at the stop entrance S100.

In detail, upon determining, at the fuel pressure determination S200, that the deviation value between the target fuel pressure and the actual fuel pressure is greater than the allowable deviation increased over the predetermined value, the fuel pressure valve 150 is opened. The deviation value subsequently again becomes greater than the allowable deviation due to the target fuel pressure continuously decreased after completion of opening of the fuel pressure valve 150 controlled based on a duty value determined before the target fuel pressure decrease. This situation is repeated and, as such, repeated control of the fuel pressure valve 150 is carried out.

That is, although the deviation value is decreased to be equal to or lower than the allowable deviation, the deviation value may be subsequently again increased over the allowable deviation and, as such, a situation requiring opening of the fuel pressure valve 150 may occur. To this end, in various embodiments of the present invention, in addition to the allowable deviation, the time when the engine RPM is equal to or lower than the return RPM is determined, to return the target fuel pressure and allowable deviation to predetermined values thereof, respectively.

The return RPM may be determined in various manners based on experimental results. The return RPM is preferably determined by an engine RPM generated at least after the target fuel pressure according to the present invention reaches the reference fuel pressure. The return RPM is more preferably determined by an engine RPM generated in a stop state of the vehicle after completion of the stop entrance of the vehicle. The latter case is more advantageous when various control parameters are taken into consideration.

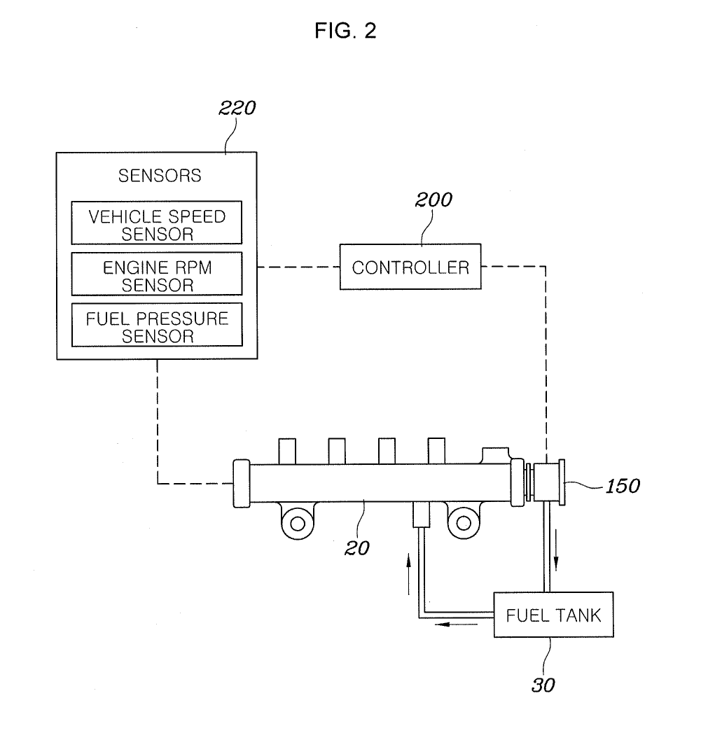

Meanwhile, referring to FIGS. 2 and 3, a system for controlling the fuel pressure valve of the vehicle in accordance with various embodiments of the present invention is illustrated. As illustrated in FIGS. 2 and 3, the control system includes the fuel pressure valve 150, which is controlled using a duty value, to be opened or closed, and functions to return, to a fuel tank 30, a fuel supplied to an injector by a fuel pump, thereby achieving a reduction in fuel pressure, and the sensor unit 220, which functions to measure a vehicle speed, an engine RPM, and a current actual fuel pressure. The control system further includes the controller 200, which decreases a target fuel pressure of the vehicle below a predetermined value determined based on an engine RPM while increasing an allowable deviation between the target fuel pressure and an actual fuel pressure measured by the sensor unit 220 upon determining that the vehicle speed is equal to or lower than a reference vehicle speed, and pressing of the acceleration pedal is released, determines whether a deviation value between the target fuel pressure and the measured actual fuel pressure is greater than the allowable deviation, determines a duty value of the fuel pressure valve 150 based on the deviation value when the deviation value between the target fuel pressure and the measured actual fuel pressure is greater than the allowable deviation, and then opens the fuel pressure valve 150 using the determined duty value, thereby decreasing the actual fuel pressure.

This will be described in detail. The opening or closing of the fuel pressure valve 150 is controlled based on a duty value. The fuel pressure valve 150 returns, to the fuel tank 30, a fuel supplied to the injector or common rail 20 by the fuel pump, thereby achieving a reduction in fuel pressure.

Meanwhile, the sensor unit 220 is provided to measure a vehicle speed, an engine RPM, and a current actual fuel pressure. The measured values are sent to the controller 200.

Upon determining that the vehicle speed is equal to or lower than a reference vehicle speed, and pressing of the acceleration pedal is released, the controller 200 decreases the target fuel pressure of the vehicle below the predetermined value determined based on an engine RPM while increasing the allowable deviation between the target fuel pressure and the actual fuel pressure measured by the sensor unit 220. The controller 200 then determines whether the deviation value between the target fuel pressure and the measured actual fuel pressure is greater than the allowable deviation. When the deviation value between the target fuel pressure and the measured actual fuel pressure is greater than the allowable deviation, the controller 200 determines a duty value of the fuel pressure valve 150 based on the deviation value, and then opens the fuel pressure valve 150 using the determined duty value, thereby decreasing the actual fuel pressure.

In accordance with the above-described fuel pressure valve control method and system, it may be possible to effectively reduce generation of noise in a fuel pressure valve to adjust the fuel pressure of a common rail.

In particular, when the vehicle speed is equal to or lower than the reference vehicle speed, and pressing of the acceleration pedal is released, the allowable deviation between the actual fuel pressure and the target fuel pressure is increased over a predetermined value. Accordingly, the engine RPM is lowered, and the target fuel pressure is decreased, as in a state in which the vehicle enters a stop state. Thus, operation noise of the fuel pressure valve may be effectively reduced.

In addition, the target fuel pressure decreased below the predetermined value becomes the reference fuel pressure before the engine RPM is decreased below the reference RPM, at which operation noise of the fuel pressure valve is recognizable. Accordingly, operation of the fuel pressure valve is completed before the engine RPM reaches the reference RPM and, as such, operation noise transmitted to the passenger may be minimized.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling a fuel pressure valve of a vehicle, comprising:
stop entrance, by a controller, of reducing a target fuel pressure below a predetermined value based on an engine RPM and increasing an allowable deviation between the target fuel pressure and an actual fuel pressure measured by a sensor when the controller determines that a current vehicle speed is equal to or lower than a reference vehicle speed, and pressing of an acceleration pedal is released;
fuel pressure determination, by the controller, of determining whether a deviation value between the target fuel pressure and the measured actual fuel pressure is greater than the allowable deviation; and
valve control, by the controller, of determining a duty value of the fuel pressure valve when the deviation value between the target fuel pressure and the measured actual fuel pressure is greater than the allowable deviation, and then controlling, by the controller, to open the fuel pressure valve using the determined duty value, thereby decreasing the actual fuel pressure.

2. The method according to claim 1, wherein the target fuel pressure is maintained at a reference fuel pressure after being decreased to be equal to the reference fuel pressure.

3. The method according to claim 2, wherein the reference fuel pressure has a value equal to a predetermined value of the target fuel pressure determined based on an engine RPM in a stop state, before the stop entrance.

4. The method according to claim 2, wherein the target fuel pressure is decreased to be equal to the reference fuel pressure at the stop entrance before the engine RPM reaches a predetermined reference revolutions per minute (RPM) set in the controller through decrease thereof.

5. The method according to claim 1, wherein, at the stop entrance, the controller decreases the target fuel pressure while increasing the allowable deviation when the vehicle is in a neutral state, the vehicle speed is equal to or lower than the reference vehicle speed, and pressing of the acceleration pedal is released.

6. The method according to claim 1, wherein, at the stop entrance, the target fuel pressure is decreased, and the allowable deviation is increased when the target fuel pressure has a value equal to or lower than a change fuel pressure, and the engine RPM has a value equal to or lower than a change RPM in a state in which the vehicle speed is equal to or lower than the reference vehicle speed, and pressing of the acceleration pedal is released.

7. The method according to claim 1, further comprising:
return determination, by the controller, of determining whether a current engine RPM is equal to or lower than a return RPM, upon determining, at the fuel pressure determination, that the deviation value between the target fuel pressure and the actual fuel pressure is equal to or lower than the allowable deviation; and
return, by the controller, of returning the target fuel pressure to the predetermined value determined based on the engine RPM upon determining, at the return determination, that the engine RPM is equal to or lower than the return RPM, and controlling the controller to return the allowable deviation to a value maintained before being increased at the stop entrance.

8. A system for controlling a fuel pressure valve of a vehicle, comprising:
a fuel pressure valve controlled using a duty value, to be opened or closed, the fuel pressure valve functioning to return, to a fuel tank, a fuel supplied to an injector by a fuel pump to achieve a reduction in fuel pressure;
sensors for measuring a vehicle speed, an engine revolutions per minute (RPM), and a current actual fuel pressure; and
a controller for decreasing a target fuel pressure of the vehicle below a predetermined value determined based on an engine RPM while increasing an allowable deviation between the target fuel pressure and an actual fuel pressure measured by the sensors upon determining that the vehicle speed is equal to or lower than a reference vehicle speed, and pressing of the acceleration pedal is released, the controller determining whether a deviation value between the target fuel pressure and the measured actual fuel pressure is greater than the allowable deviation, determining a duty value of the fuel pressure valve based on the deviation value when the deviation value between the target fuel pressure and the measured actual fuel pressure is greater than the allowable deviation, and then opening the fuel pressure valve using the determined duty value, thereby decreasing the actual fuel pressure.
